(19) United States
(12) Patent Application Publication
(10) Pub. No.: US 2010/0206974 A1
(43) Pub. Date: Aug. 19, 2010

(54) ROLLER PRESS WITH ADJUSTABLE PLATES

(75) Inventors: Lars Demuth, Holte (DK); Nicolaj Stenberg Balk Moller, Kobenhavn (DK)

Correspondence Address: Patent Docket Department;Armstrong Teasdale LLP, One Metropolitan Square, Suite 2600, St. Louis, MO, 63102-2740, US

(73) Assignee: FLSMIDTH A/S, Copenhagen (DK)

(21) Appl. No.: 12/667,117

(22) PCT Filed: Jul. 7, 2008
(86) PCT No.: PCT/EP2008/058762

§ 371 Date: Dec. 29, 2009

(30) Foreign Application Priority Data
Jul. 10, 2007 (DK) PA 2007 01012

(51) Int. Cl. B02C 4/28

(52) U.S. Cl. 241/222

(57) ABSTRACT

A roller press for grinding particulate material, such as cement raw materials, cement clinker and similar materials is described, the roller press (1) comprising two rollers (2, 3) rotating in opposite directions, where one roller is movably mounted relative to the second roller, and where the rollers (2, 3) between them form a roller gap (4). A feed system has at least one inclined plate section (5) for regulating the feeding of particulate material along the axial extension of the roller gap (4) and the inclined plate section (5), in the axial direction of the rollers, comprises at least two substantially parallel plates (6, 7), substantially positioned in the same plane, and independently movable back and forth relative to the roller gap (4). Thus it is possible to regulate the feeding of material over the axial extension of the roller gap, thereby avoiding distortion of the movable roller.

The present invention relates to a roller press for grinding particulate material such as cement raw materials, cement clinker and similar materials, the roller press comprising two rollers rotating in opposite directions, where one roller is movably mounted relative to the second roller and pressed towards the second roller by hydraulic cylinders or the like, and where the rollers between them form a roller gap, and a feed system comprising at least one inclined plate section for regulating the quantity of particulate material which is fed along the axial extension of the roller gap.

A roller press of the aforementioned kind is, for example, known from patent application DE 35 35 406 A1. This German document describes how an inclined plate is capable of regulating the feeding of material to the roller gap. For this type of roller press, a distortion of the position of the movable roller (in the form of twisting) can occur since the feeding of material cannot be adjusted over the axial extension of the rollers. Distortion during operation of the movable roller occurs primarily due to axial segregation of the material in the feed shaft. This segregation may entail the presence of fine material at one end of the roller gap and coarse material at the other end of the roller gap. This generates an uneven grinding cushion thickness along the roller gap, resulting in distortion of the position of the movable roller. Preventive action must be taken to avert distortion since, otherwise, the pressure profile over the axial extension of the rollers will be very irregular, giving rise to several disadvantages. First and foremost, grinding of the material will be uneven, but it will also entail excessive wear rates on the rollers and undesirable stress loading of the roller press construction. Furthermore, twisting of the movable roller will make it impossible to achieve absolute tightness of the seals in the bearings of the movable roller.

An attempt to solve the problem of distortion has been made in patent application DE 42 26 182 A1. Here a description is made of a roller press where differentiation of the material feed is achieved over the axial extension of the roller gap. In this document, two flow control plates are rotatably fitted opposite one another centrally on the wall of the feed shaft. Hence it is possible to increase or decrease the flow of material to the roller gap, through rotation of the feed control plates. For this embodiment it will not be possible to dispense with a gate between the material silo and the feed shaft since, in connection with the rotation, the feed control plates will close at one side and open at the other side, thereby feeding material to the roller gap all the time. For this reason why it will not be possible to effect a gentle start-up of the roller press where the material feed to the roller gap is slowly increased across the entire roller length. DE 42 26 182 A1 further describes an embodiment where two plate sections, fitted opposite one another in the feed shaft, each comprise two plates which control the feeding along the axial extension of the roller gap by means of hinges and actuators. However, this solution is not considered to be optimal since the controlling of each of the two plates in each plate section, by means of actuators, will depend on the position of the other plate, entailing significant complications for the control function. Furthermore, the actuators will be exposed continuously to the material which falls through the hinges and a continual amount of dust which means that the use of hydraulics in the actuators will not be an attractive option. Also the hinging system between the feed shaft and plate section, and particularly the hinging system between the two plates is definitively deemed to be unsuitable for the specific operating environment.

It is an objective of the present invention to provide a roller press by means of which the aforementioned deficiencies and irregularities are eliminated.

This is obtained by a roller press of the kind indicated in the introduction and being characterized in that the inclined plate section, in the axial direction of the rollers comprises at least two substantially parallel plates, substantially positioned in the same plane, and the parallel plates, being independently adjustable back and forth relative to the roller gap.

This will make it possible to avoid or counteract distortion or twisting of the movable roller at a very early stage. Distortion is counteracted by increasing the feeding of material to the side of the roller gap where the roller gap is too narrow or by decreasing the feeding of material to the side of the roller gap where the roller gap is too wide, or by doing both. The distribution of the material is effected through an individual displacement of the inclined plates in the feed system back and forth relative to the roller gap so that the roller gap receives the desired material feed rate over its length.

The plate section may further comprise three, four or more plates so as to increase the options for adjusting the distribution of the material over the length of the roller gap. With three, four or more plates in the plate section, improved opportunities will also exist to compensate for the wear which will occur on the rollers. When the rollers incur wear, the pressure profiles of the rollers will be changed, leading to a change of the grinding process. The changed pressure profiles of the rollers resulting from wear exposure can be compensated for through the application of appropriate material feed rates relative to the wear zones. In this way appropriate pressure profiles will be re-established, hence compensating for the wear incurred on the rollers.

Furthermore, the plate section may be adjusted so that the feed system can shut off the roller gap, thereby preventing feeding of material to the roller gap. As a result, it is possible to dispense with a gate over the feed system, since the plate section functions as a gate, and this reduces the costs for a complete system with a material silo.

One further advantage, when the inlet to the roller gap can be closed, is that it is possible for the plate section slowly to be displaced from the closed position in order to attain a uniform and gradual opening over the entire length of the roller gap. This leads to a slow increase in the material feed rate to the roller gap. The result is a reduction of the wear incurred on the roller press, thereby reducing the maintenance costs for the roller press.

In one embodiment of the invention the feed system comprises a second inclined plate section which is positioned opposite the first plate section. Hence it is possible to shut off the material feed to the roller gap without having to move the first plate section to the wall on the shaft in the feed system.

In a preferred embodiment of the invention the second inclined plate section comprises at least two substantially parallel plates, positioned substantially in the same plane, which, independently of one another, can be displaced back and forth relative to the roller gap. This increases the scope for adjusting the feeding of material across the length of the roller gap.

It is preferred that the inclined plates are placed at an acute angle of 5° to 85° relative to a vertical plane through the longitudinal centreline of the roller gap.

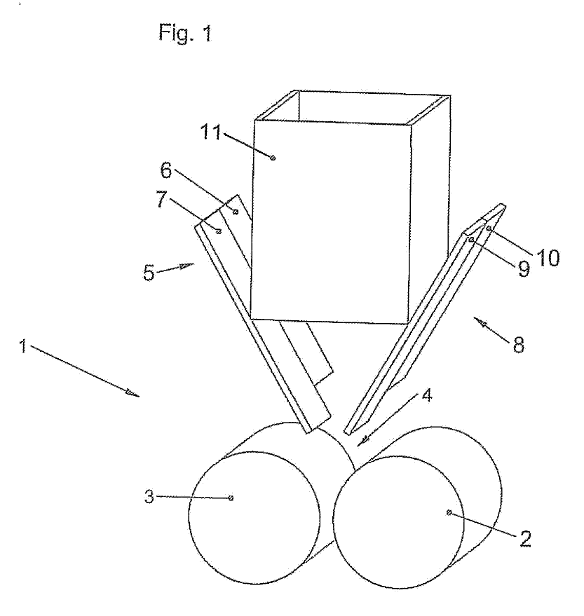

The invention will now be described in further detail with reference to the drawing, being diagrammatical, with its only figure, FIG. 1, showing a three-dimensional image of a roller press according to the invention.

FIG. 1 shows a roller press 1 which comprises two oppositely rotating rollers 2 and 3 where the rollers between them form a roller gap 4 and a feed system which comprises a feed chute 11 and at least an inclined plate section 5 for regulating the feeding of particulate material along the axial extension of the roller gap 4 where the inclined plate section 5, in the axial direction of the rollers, comprises at least two substantially parallel plates 6 and 7 which, independently of one another, can be displaced back and forth along their planes relative to the roller gap 4. The plates are shown as having different lengths, just to illustrate the different positions of the plates relative to the roller gap.

In the embodiment shown in FIG. 1 the feed system in the roller press 1 comprises a second inclined plate section 8 which is positioned opposite the first inclined plate section 5. The second inclined plate section 8 comprises at least two substantially parallel plates 9 and 10 which, independently of one another, can be displaced back and forth relative to the roller gap in the same way as the plates 6 and 7.

In a further embodiment (not shown), and in which only the first inclined plate section 5 with plates 6, 7 is utilised, a stationary component of the feed system such as a plate positioned in a fixed location substantially the same as the plate section 8 of the example shown in FIG. 1, or a vertical stop plate, can be used with the movable plates 6, 7 to enable the flow rate adjustment.

It is preferred that each of the inclined plates 6, 7, 9 and 10 is positioned at an acute angle of 5° to 85° relative to a vertical plane which follows the centreline for the axial extension of the roller gap.

1. A roller press for grinding particulate material such as cement raw materials, cement clinker and similar materials, said roller press comprising:
two rollers configured to rotate in opposite directions, where one of said rollers is movably mounted relative to a second of said rollers and wherein said rollers form a roller gap therebetween; and
a feed system comprising at least one inclined plate section for regulating the quantity of particulate material which is fed along the axial extension of the roller gap, said inclined plate section, comprising, in the axial direction of said rollers, at least two substantially parallel plates substantially positioned in the same plane, said parallel plates being independently adjustable back and forth relative to the roller gap.

2. A roller press according to claim 1 wherein said feed system comprises a second inclined plate section disposed opposite said first inclined plate section.

3. A roller press according to claim 2 wherein said second inclined plate section (8) comprises at least two substantially parallel plates, substantially positioned in the same plane, being independently adjustable back and forth relative to the roller gap.

4. A roller press according to claim 3 wherein said at least two substantially parallel plates associated with said second inclined plate section are positioned at an acute angle of 5° to 85° relative to a vertical plane which follows the centerline for an axial extension of the roller gap.

5. A roller press according to claim 1 wherein said at least two substantially parallel plates are positioned at an acute angle of 5° to 85° relative to a vertical plane which follows the centerline for an axial extension of the roller gap.
